(19) United States
(12) Patent Application Publication
(10) Pub. No.: US 2011/0259208 A1
(43) Pub. Date: Oct. 27, 2011

(54) STEAM GENERATING DEVICE AND COOKER

(76) Inventors: Shinya Ueda, Osaka (JP); Takashi Utsumi, Osaka (JP)

(21) Appl. No.: 13/142,404

(22) PCT Filed: Dec. 28, 2009
(86) PCT No.: PCT/JP2009/071804

§ 371 Date: Jun. 27, 2011

(30) Foreign Application Priority Data
Jan. 8, 2009 (JP) 2009-002349
Jan. 8, 2009 (JP) 2009-002351

(51) Int. Cl. A47J 36/00

(52) U.S. Cl. 99/447; 122/448.1

(57) ABSTRACT

A steam generating device comprising: a housing (2) having a cavity therein; a water supply port (3) open in the housing (2); a water supply device (21) for supplying water into the housing (2) from the water supply port (3); a steam generating heater (4) embedded in the housing (2) and evaporating the water supplied from the water supply port (3); a discharge port (8) open in the housing (2) and discharging the steam generated by the steam generating heater (4); and a temperature sensor (5) for detecting the temperature of the housing (2). The water supply device (21) is driven when the temperature of the housing (2) becomes higher than a predetermined driving temperature (T1), and the water supply device (21) is stopped when the temperature of the housing (2) becomes lower than a predetermined stop temperature (T2) that is lower than the predetermined driving temperature (T1).

### TECHNICAL FIELD

The present invention relates to a steam generating device that generates steam and a cooker using the same.

### BACKGROUND ART

Patent Document 1 discloses a cooker using a steam generating device according to the conventional technique. In this cooker, the steam generating device is installed on an outer wall of a heating chamber that houses an object to be cooked. The steam generating device has a housing made of a die casting of a metal such as aluminum. The housing includes a box-shaped main body portion having an open surface on one surface thereof and a lid portion that covers the open surface, so that a cavity is formed inside the housing.

In the main body portion, a steam generating heater is embedded by molding in upper and lower wall surfaces thereof, and a water supply port is formed at a center portion of a side wall thereof in the vertical direction. The water supply port is connected to a water supply tank via a water supply pump so that water is supplied into the housing through the water supply port. At an upper portion of the lid portion, an ejection port for ejecting steam is provided so as to face toward the inside of the heating chamber. Furthermore, in the main body portion, a plurality of fins for heat exchange and a temperature sensor that detects the temperature in the housing are provided. Some of the fins are each disposed so as to cover the lower side of the ejection port.

When water is supplied into the steam generating device through the water supply port, the water is stored in a bottom portion of the housing, and steam is generated by driving of the steam generating heater. The steam thus generated ascends in the housing to come in contact with the highly-heated housing wall surfaces and fins and thus is further heated. As a result, the highly-heated steam is ejected into the heating chamber via the ejection port. Using the steam thus supplied into the heating chamber, an object to be cooked is cooked.

The steam generating device is continuously supplied with water at a predetermined flow rate by the water supply pump, and the temperature in the housing is monitored by the temperature sensor. Heating by the steam generating heater causes water in the housing to be evaporated, and when the temperature in the housing becomes higher than a predetermined temperature, the steam generating heater is deactivated. When, in consequence of water supply, the temperature in the housing becomes lower than the predetermined temperature, the steam generating heater is driven. These operations are performed in repeated cycles, as a result of which steam is ejected through the ejection port.

### LIST OF CITATIONS

### Patent Literature

Patent Document 1: JP-A-2006-84059 (pages 3 to 8, FIG. 3, and FIG. 6)

### SUMMARY OF THE INVENTION

### Technical Problems

According to the above-described conventional steam generating device, however, water is continuously supplied by the water supply pump, and the steam generating heater is turned on/off depending on the temperature in the housing. Because of this, water may accumulate to a large amount in the housing during a time from when the steam generating heater is started to be driven to when a heated state thereof is attained. It has been a problem that, in this case, if the water in the housing comes to a boil and bumping thereof occurs, the water spurts out through the ejection port to leak into the heating chamber. Such water leakage into the heating chamber through the ejection port causes water to adhere to an object to be cooked, resulting in a failure to achieve cooking with a good result. Particularly in a case where hard water is supplied through the water supply port, since bumping thereof is highly likely to occur, spurting out of the water through the ejection port occurs to a considerable degree.

Furthermore, if power supply to the steam generating heater is reduced, the evaporation amount with respect to the amount of water supplied from the water supply pump is decreased. In such a case, the housing is not heated to a temperature at which the steam generating heater is deactivated and is continuously supplied with water. It has also been a problem that this causes water to overflow through the ejection port to leak into the heating chamber.

Furthermore, among the fins, the ones each disposed on the lower side of the ejection port are provided in the main body portion having the steam generating heater and thus are maintained at a high temperature. Because of this, when bumping of water accumulated in the housing occurs under heating by the steam generating heater and thus carries the water up on the fins, water droplets thereby formed on the fins are brought to a bumping state again. It has also been a problem that this causes water to spurt out through the ejection port to leak into the heating chamber.

It is an object of the present invention to provide a steam generating device that can prevent water leakage through an ejection port for ejecting steam and a cooker using the same.

### Solution to the Problems

In order to achieve the above-described object, a steam generating device according to the present invention includes: a housing having a cavity inside; a water supply port that is open into the housing; a water supply unit that supplies water into the housing through the water supply port; a steam generating heater that is embedded in the housing and evaporates water supplied through the water supply port; an ejection port that is open into the housing and through which steam generated by the steam generating heater is ejected; and a temperature sensor that detects a temperature in the housing. In the steam generating device, when the temperature in the housing becomes higher than a predetermined driving temperature, the water supply unit is driven, and when the temperature in the housing becomes lower than a predetermined deactivation temperature lower than the driving temperature, the water supply unit is deactivated.

According to this configuration, when water is supplied into the housing through the water supply port by driving of the water supply unit, the water is stored in a bottom portion of the housing, and steam is generated by driving of the steam generating heater. The steam thus generated ascends in the housing and then is ejected through the ejection port. The temperature in the housing is monitored by the temperature sensor, and when the temperature becomes higher than the driving temperature, water is supplied from the water supply unit. When, in consequence of water supply, the temperature in the housing is decreased and becomes lower than the deactivation temperature, the water supply unit is deactivated.

Furthermore, in the present invention, in the steam generating device configured as above, the deactivation temperature is set to a temperature higher than 100° C. According to this configuration, steam is generated with the temperature in the housing maintained at a temperature higher than 100° C.

Furthermore, a steam generating device according to the present invention includes: a housing that includes a box-shaped metallic main body portion having an open surface and a lid portion that covers the open surface, so that a cavity is formed inside the housing; a water supply port through which water is supplied into the housing; a steam generating heater that is embedded in the main body portion and evaporates water supplied through the water supply port; an ejection port that is open into the main body portion at a level above the level of the steam generating heater and through which steam generated by the steam generating heater is ejected; and a blocking portion that is disposed between the ejection port and the steam generating heater so as to extend from the lid portion to the vicinity of an inner wall of the main body portion.

According to this configuration, when water is supplied into the housing through the water supply port, the water is stored in the bottom portion of the housing, and steam is generated by driving of the steam generating heater. The steam thus generated ascends in the housing and then is ejected through the ejection port. Water, which has been brought to a bumping state in the bottom portion of the housing by the steam generating heater, is blocked by the blocking portion. The blocking portion extends from the lid portion at a temperature lower than the temperature at the main body portion, and thus droplets of water that has been carried up on the blocking portion through bumping drip from there on the blocking portion into the housing.

Furthermore, in the present invention, in the steam generating device configured as above, the lid portion is joined to the main body portion via a gasket. According to this configuration, the gasket provides sealing between the main body portion and the lid portion. Furthermore, heat transfer from the main body portion having the steam generating heater to the lid portion is suppressed.

Furthermore, in the present invention, in the steam generating device configured as above, the blocking portion is constituted by an inclined surface. According to this configuration, droplets of water that has been carried up on the blocking portion constituted by an inclined surface flows down from there on the blocking portion to drip into the housing.

Furthermore, in the present invention, in the steam generating device configured as above, the blocking portion has a side surface portion provided in a standing manner on each lateral side of the ejection port and thus has a U-shape in cross section. According to this configuration, water being in a bumping state is blocked by the blocking portion covering the lower side and lateral sides of the ejection port.

Furthermore, in the present invention, in the steam generating device configured as above, the ejection port protrudes into the housing and overlaps the blocking portion in a planar view.

Furthermore, in the present invention, in the steam generating device configured as above, a lower inner wall surface of the ejection port is inclined downward in a direction toward the lid portion. According to this configuration, water droplets produced inside the ejection port by condensation resulting from cooling flow down the lower inner wall surface of the ejection port to drip on the blocking portion and then drip from the blocking portion into the housing.

Furthermore, in the present invention, in the steam generating device configured as above, the water supply port is provided in the lid portion. According to this configuration, the lid portion is cooled by water passing through the water supply port.

Furthermore, in the present invention, in the steam generating device configured as above, the lid portion is made of ceramic. According to this configuration, the lid portion is decreased in thermal conductivity, and thus heat transfer from the main body portion having the steam generating device to the lid portion is suppressed.

Furthermore, a cooker according to the present invention includes: the steam generating device having any one of the above-described configurations; a heating chamber that houses an object to be cooked and is supplied with steam through the ejection port; a circulation fan that circulates steam in the heating chamber; and a convection heater that heats steam being circulated by the circulation fan. According to this configuration, cooking is performed using steam that is supplied from the steam generating device into the heating chamber and is circulated by the circulation fan. The steam being circulated by the circulation fan is heated by the convection heater so as to be maintained at a predetermined temperature.

Furthermore, in the present invention, in the cooker configured as above, respective duty ratios of the steam generating heater and the convection heater are controlled so that a steam generation period in which the steam generating heater is driven and a heating period in which the convection heater is driven are brought about in repeated cycles, and a period in which the water supply unit is driven is synchronized with timing for driving the steam generating heater.

According to this configuration, the steam generating heater and the convection heater are driven by being supplied with power alternately, so that the steam generation period and the heating period are brought about in repeated cycles. When the temperature in the housing becomes higher than the driving temperature, the water supply unit is driven during the steam generation period in synchronization with the steam generating heater.

Furthermore, in the present invention, in the cooker configured as above, at a time preceding the completion of cooking by a predetermined length of time, the water supply unit is deactivated regardless of the temperature in the housing.

Furthermore, in the present invention, in the cooker configured as above, when the temperature in the housing exceeds a predetermined temperature during the predetermined length of time, the steam generating heater is deactivated.

### Advantageous Effects of the Invention

According to the present invention, when the temperature in the housing of the steam generating device becomes higher than the predetermined driving temperature, driving of the water supply unit is started, and when the temperature in the housing becomes lower than the predetermined deactivation temperature lower than the driving temperature, the driving of the water supply unit is halted. Thus, water does not accumulate in the housing during a time from when the steam generating heater is started to be driven to when a heated state thereof is attained, so that a phenomenon can be prevented in which the water is brought to a bumping state to spurt out through the ejection port. Furthermore, if power supply to the steam generating heater is reduced and the temperature in the housing thus is decreased, water supply is halted, and thus water can be prevented from overflowing through the ejection port. This can prevent water leakage through the ejection port, thereby allowing cooking to be performed with a good result.

Furthermore, according to the present invention, the blocking portion is provided that extends from the lid portion covering the open surface of the main body portion in which the steam generating heater is embedded, and the blocking portion is disposed between the ejection port and the steam generating heater so as to extend to the vicinity of an inner wall of the main body portion, and thus water being in a bumping state in a bottom portion of the housing can be blocked by the blocking portion. Furthermore, the blocking portion is provided on the lid portion at a temperature lower than the temperature at the main body portion, and thus droplets of water that has been carried up on the blocking portion through bumping of the water caused in the bottom portion of the housing are not brought to a bumping state on the blocking portion but drip into the housing. This can prevent water leakage through the ejection port, thereby allowing cooking to be performed with a good result.

### BRIEF DESCRIPTION OF DRAWINGS

FIG. 1 A right side view showing an inside of a cooker according to an embodiment of the present invention.

FIG. 2 A front view showing the inside of the cooker according to the embodiment of the present invention.

FIG. 3 A cross-sectional front view showing a steam generating device in the cooker according to the embodiment of the present invention.

FIG. 4 A cross-sectional view taken on line A-A of FIG. 3.

FIG. 5 A block diagram showing the configuration of the cooker according to the embodiment of the present invention.

FIG. 6 A timing chart showing respective driving pulses of the steam generating heater, a water supply pump, and a convection heater in the cooker according to the embodiment of the present invention.

FIG. 7 A flow chart showing the operation of the cooker according to the embodiment of the present invention.

FIG. 8 A diagram showing variations in temperature in a housing of the steam generating device in the cooker according to the embodiment of the present invention.

### DESCRIPTION OF EMBODIMENTS

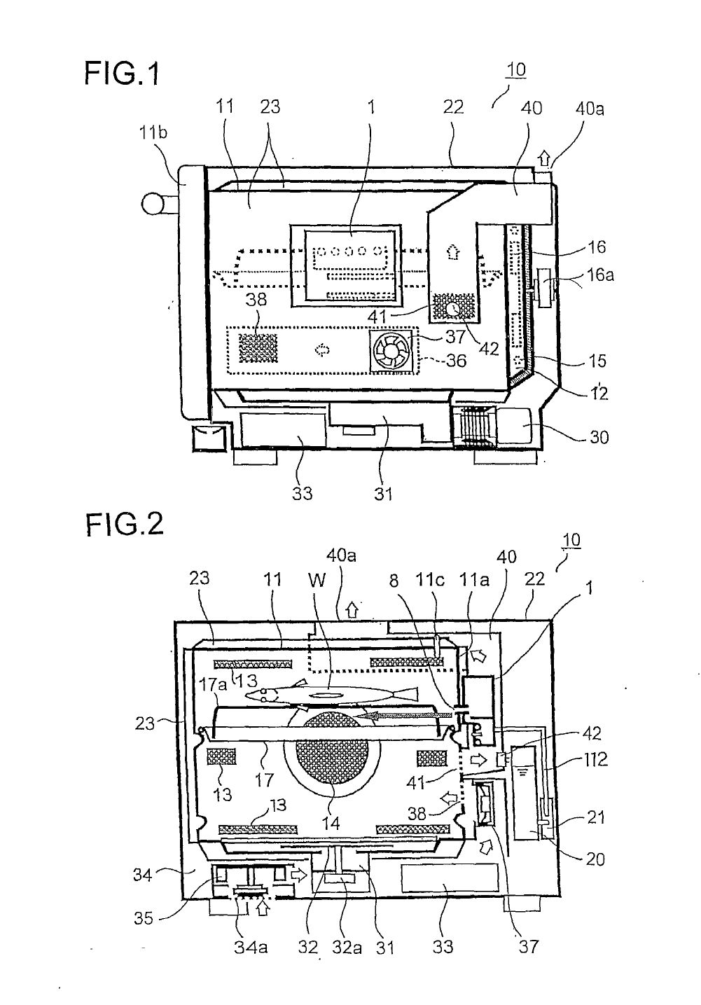

Hereinafter, an embodiment of the present invention will be described with reference to the appended drawings. FIGS. 1 and 2 are a right side view and a front view showing an inside of a cooker according to one embodiment, respectively. A cooker 10 has, in a main body casing 22, a heating chamber 11 that has substantially a rectangular parallelepiped shape and houses an object to be cooked. The side walls and ceiling wall of the heating chamber 11 are covered with a heat shield plate 23 so as to be thermally shielded, and the front surface of the heating chamber 11 is opened/closed by a door 11b.

A temperature sensor 11c that detects the room temperature in the heating chamber 11 is provided on the top surface of the heating chamber 11. Based on a temperature detected by the temperature sensor 11c, an after-mentioned convection heater 15 is controlled. A tray 17 on which a rack 17a is placed is disposed in the heating chamber 11. An object W to be cooked is placed on the rack 17a.

An outside air inflow duct 34 is formed between the heating chamber 11 and the main body casing 22 so as to extend on the lower side and right lateral side of the heating chamber 11. The outside air inflow duct 34 has a suction port 34a that is open on the bottom surface of the main body casing 22. In a lower portion of the outside air inflow duct 34, a cooling fan 35, an electrical equipment portion 33, and a magnetron 30 are disposed. In a side portion of the outside air inflow duct 34, an air supply duct 36 having an air supply fan 37 is disposed. The air supply duct 36 has an air supply port 38 that is open at a front portion of a side wall 11a that is one of the side walls of the heating chamber 11.

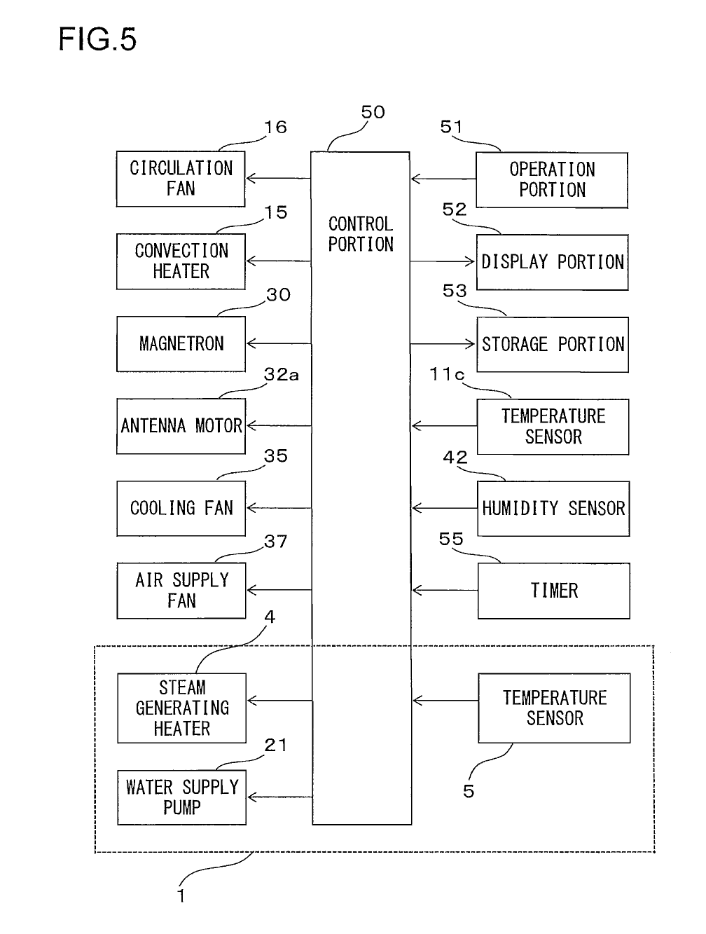

The electrical equipment portion 33 has driving circuits that respectively drive various parts of the cooker 10, a control portion 50 (see FIG. 5) that controls the driving circuits, etc., and a multitude of heat generating elements are mounted in the electrical equipment portion 33. The magnetron 30 supplies microwaves into the heating chamber 11 via a waveguide 31. An antenna 32 that is rotated by an antenna motor 32a is disposed in the waveguide 31, and thus microwaves are supplied to the heating chamber 11 in a uniform manner.

The cooling fan 35 takes outside air into the outside air inflow duct 34 via the suction port 34a and thereby cools the electrical equipment portion 33 and the magnetron 30, which generate heat. The outside air taken into the outside air inflow duct 34 flows out through an opening (not shown) formed on the back surface or the like of the main body casing 22. Furthermore, driving the air supply fan 37 causes part of the outside air to flow into the air supply duct 36 so as to be supplied to the heating chamber 11 through the air supply port 38.

In a back portion of the side wall 11a of the heating chamber 11, an air discharge duct 40 is led out via an air discharge port 41. The air discharge duct 40 is formed so as to extend to a back side of the heating chamber 11 and has an open end 40a that is open on the top surface of the main body casing 22. Furthermore, a humidity sensor 42 that detects the humidity of exhaust air at the air discharge port 41 is provided in the air discharge duct 40.

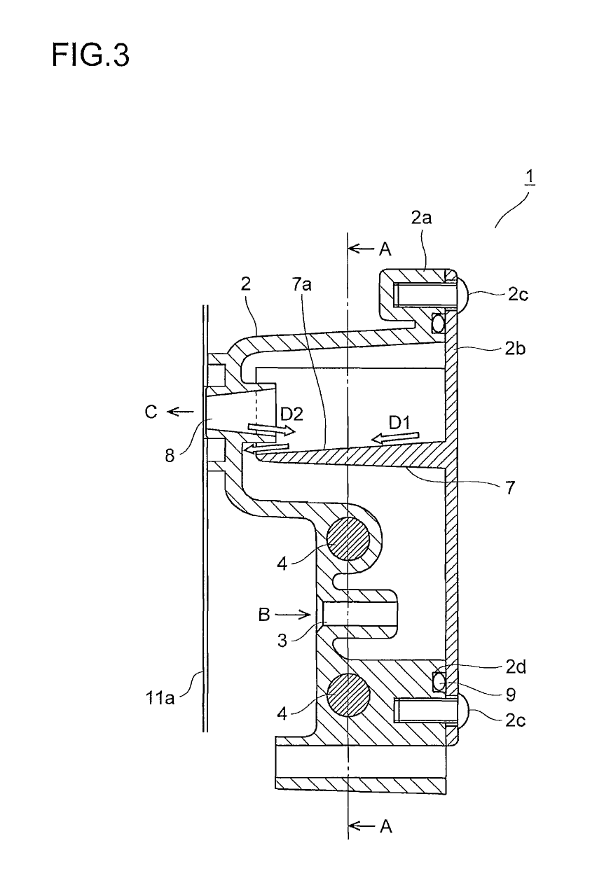

A steam generating device 1 that supplies steam to the heating chamber 11 via an ejection port 8 is installed at an upper portion of the side wall 11a of the heating chamber 11. A demountable water supply tank 20 is disposed on a lateral side of the steam generating device 1. A water supply pump 21 (water supply unit) connected to a water supply port 3 (see FIG. 3) of the steam generating device 1 is disposed on a back side of the water supply tank 20.

The steam generating device 1 is disposed at the upper portion of the side wall 11a of the heating chamber 11, and the water supply tank 20 is disposed in a lower portion of the main body casing 22. This prevents water from flowing, under its own weight, from the water supply tank 20 into the steam generating device 1. The water supply pump 21 is made up of a tube pump and delivers water through a tube 112. The water supply tank 20 is connected to the water supply pump 21 via a fitting (not shown). Driving the water supply pump 21 causes water to be supplied from the water supply tank 20 into a housing 2 (see FIG. 3) of the steam generating device 1.

A circulation duct 12 is provided behind the heating chamber 11. The circulation duct 12 has an air suction port 14 at a center portion of the back wall of the heating chamber 11 and a plurality of blow-out ports 13 at a portion of the back wall of the heating chamber 11 around the center portion. In the circulation duct 12, a circulation fan 16 and the convection heater 15 are provided. The circulation fan 16 is driven to be rotated by a fan motor 16a. The circulation fan 16 sucks steam in the heating chamber 11 into the circulation duct 12 through the air suction port 14 and blows the steam out through the blow-out ports 13. The convection heater 15 is made up of a ring-shaped sheathed heater disposed around the circulation fan 16 and maintains steam flowing through the circulation duct 12 at a predetermined temperature.

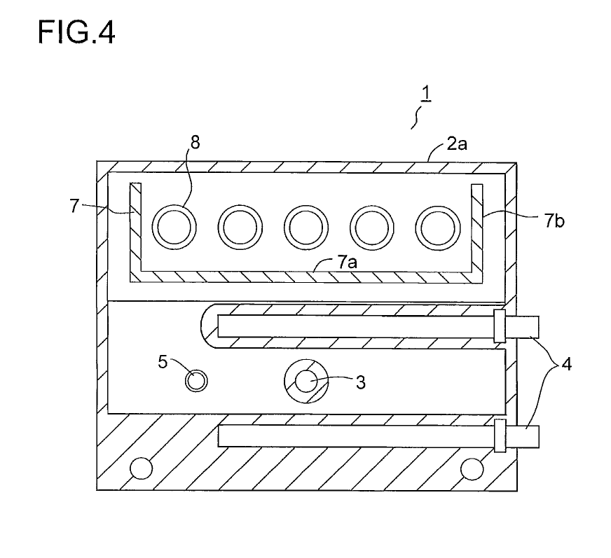

FIG. 3 shows a cross-sectional front view of the steam generating device 1. FIG. 4 shows a cross-sectional view taken on line A-A of FIG. 3. The steam generating device 1 has the housing 2 made of a metal die casting. In the housing 2, an open surface of a box-shaped main body portion 2a is closed by a lid portion 2b that is joined with a screw 2c to the main body portion 2a, so that a cavity is formed inside the housing 2. It is preferable that aluminum or an aluminum alloy be used as a material of the housing 2 since they provide good casting performance and have high thermal conductivities.

A ring-shaped groove 2d is formed around the open surface of the main body portion 2a. A ring-shaped gasket 9 is disposed in the groove 2d so as to provide sealing between the main body portion 2a and the lid portion 2b. Since sealing of the housing 2 is achieved with the gasket 9, respective surfaces of the lid portion 2b and the main body portion 2a opposed to each other have been processed to have a predetermined degree of roughness, so that minute gaps are formed between the lid portion 2b and the main body portion 2a. This suppresses heat transfer from the main body portion 2a having an after-mentioned steam generating heater 4 to the lid portion 2b.

In a lower portion of the main body portion 2a, the steam generating heaters 4 made up of sheathed heaters are arranged in two upper and lower rows. The water supply port 3 connected to the water supply pump 21 (see FIG. 2) is open between the steam generating heaters 4 in the upper and lower rows. The steam generating heaters 4 are embedded by molding in the housing 2 and thus are in close contact with the main body portion 2a, so that heat of the steam generating heaters 4 is conducted efficiently to the main body portion 2a. Thus, using heat conducted from the steam generating heaters 4 to the housing 2, water that is allowed to drip from the water supply port 3 and accumulates in a bottom portion of the housing 2 is evaporated to form steam.

Furthermore, in a side portion between the steam generating heaters 4 in the upper and lower rows, a temperature sensor 5 that detects the temperature in the housing 2 is embedded by molding.

In an upper portion of the main body portion 2a, a plurality of the ejection ports 8 that eject steam are provided so as to face the side wall 11a of the heating chamber 11. Each of the ejection ports 8 protrudes into the housing 2 and has a lower inner wall surface inclined downward in a direction toward the lid portion 2b. The ejection ports 8 are formed on a plane protruding with respect to a lower portion of the housing 2 in which the steam generating heaters 4 are embedded. Thus, the lower portion of the housing 2, which is heated to a high temperature by the steam generating heaters 4, is disposed away from the wall surface 11a of the heating chamber 11. This can simplify a heat-resistant structure of the heating chamber 11.

A blocking portion 7 is provided integrally with the lid portion 2b so as to protrude toward the inside of the housing 2. The blocking portion 7 is formed so as to extend to the vicinity of a wall surface of the main body portion 2a, which is opposed thereto, and a bottom surface 7a of the blocking portion 7 is disposed between the ejection ports 8 and the steam generating heaters 4. Furthermore, the blocking portion 7 has a side surface portion 7b provided in a standing manner on each lateral side of the ejection ports 8 and thus has a U-shape in cross section. The bottom surface 7a of the blocking portion 7 is formed so as to be inclined downward in a direction away from the lid portion 7a and disposed so as to overlap, in a planar view, the ejection ports 8 protruding into the housing 2.

FIG. 5 is a block diagram showing the configuration of the cooker 10. The cooker 10 has the control portion 50 that is disposed in the electrical equipment portion 33 and controls the various parts. The circulation fan 16, the convection heater 15, the magnetron 30, the antenna motor 32a, the cooling fan 35, the air supply fan 37, an operation portion 51, a display portion 52, a storage portion 53, the temperature sensor 11c, the humidity sensor 42, and a timer 55 are connected to the control portion 50. Furthermore, the steam generating heaters 4 of the steam generating device 1, the water supply pump 21, and the temperature sensor 5 are controlled by the control portion 50.

The timer 55 measures a cooking time, etc. The operation portion 51 is provided on a lateral side of the heating chamber 11 and performs a cooking menu selecting operation, a cooking starting operation, etc. The display portion 52 is made up of a liquid crystal panel, etc. disposed on the lateral side of the heating chamber 11 and displays operation menus, an operating state of the cooker 10, etc. The storage portion 53 stores databases on operation programs and cooking menus of the cooker 10 and temporarily stores a result of a computation performed by the control portion 50.

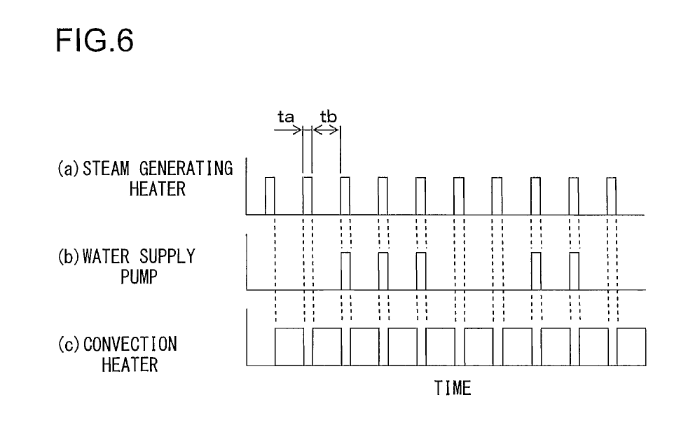

FIG. 6 is a schematic timing chart showing respective driving pulses of the steam generating heaters 4, the water supply pump 21, and the convection heater 15. Respective duty ratios of the steam generating heaters 4 and the convection heater 15 are controlled. Thus, a steam generation period to in which the steam generating heaters 44 are driven during a predetermined on-time and a heating period tb in which the convection heater 15 is driven during a predetermined on-time are brought about in repeated cycles.

Furthermore, the water supply pump 21 is driven during the steam generation period ta in synchronization with the steam generating heater 4 and, as will be described later, is deactivated when the temperature in the housing 2 of the steam generating device 1 becomes high. The circulation fan 16 is driven during the heating period tb in synchronization with the convection heater 15. The circulation fan 16 may also be driven during the heating period tb and during the steam generation period ta in a continuous manner.

In the cooker 10 configured as above, upon starting of cooking using microwaves, the magnetron 30 and the antenna motor 32a are driven. Furthermore, the cooling fan 35 and the air supply fan 37 are also driven. The magnetron 30 supplies microwaves into the heating chamber 11 via the waveguide 31, and the object W to be cooked is heated using the microwaves.

Driving the cooling fan 35 causes outside air to flow into the outside air inflow duct 34 through the suction port 34a. The outside air that has flowed into the outside air inflow duct 34 cools the electrical equipment portion 33 and the magnetron 30 and then is discharged to the outside. Part of the outside air heated as a result of having cooled the electrical equipment portion 33 and the magnetron 30 is guided to the air supply duct 36 by the air supply fan 37.

The outside air flowing through the air supply duct 36 is supplied to the heating chamber 11 through the air supply port 38. At this time, since the air supply port 38 is disposed at a front portion of the heating chamber 11, the airflow blown out through the air supply port 38 flows along the door 11b. Thus, using air heated as a result of having cooled the electrical equipment portion 33 and the magnetron 30, the occurrence of condensation on the door 11b can be prevented.

Upon reception of the air supplied through the air supply port 38, air in the heating chamber 11 is discharged through the air discharge port 41 to flow through the air discharge duct 40 and then is emitted to the atmosphere through the open end 40a. The humidity of the air flowing through the air discharge duct 40 is detected by the humidity sensor 42. Under heating by microwaves, steam is generated from the object W to be cooked, and when the humidity in the heating chamber 11 attains a predetermined value, upon detection thereof by the humidity sensor 42, it is determined that timing for completing the cooking has come. The cooking using microwaves thus is completed.

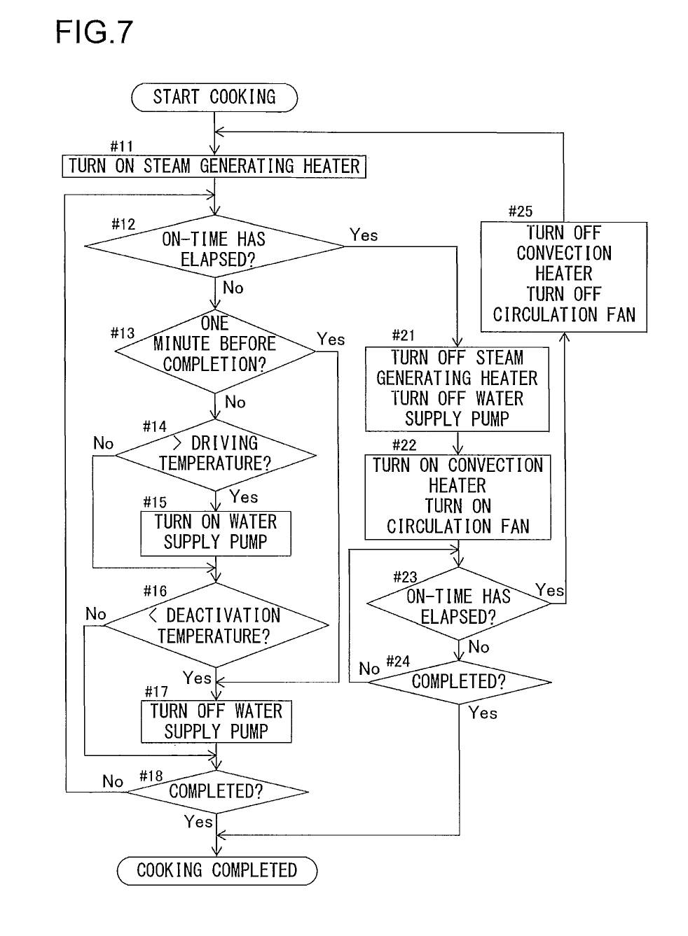

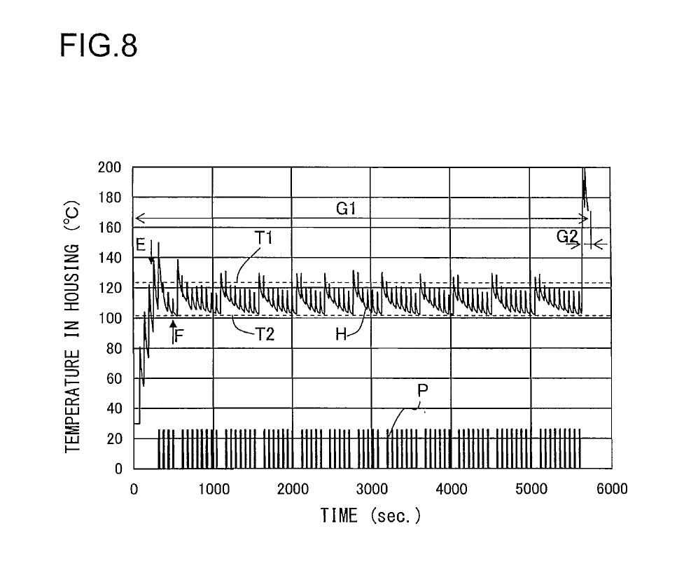

When cooking using steam is performed, the water supply tank 20 storing water is mounted. Then, the object W to be cooked is placed on the rack 17a, and upon selection of a cooking menu, the cooking is started. FIG. 7 is a flow chart showing the operation of performing cooking using steam. Furthermore, FIG. 8 is a diagram showing an example of how the temperature in the housing 2 of the steam generating device 1 varies during cooking. In this figure, the vertical axis indicates a temperature in the housing 2 denoted H (unit: ° C.), and the horizontal axis indicates a time (unit: second). In the figure, P represents a driving pulse of the water supply pump 21.

Upon starting of the cooking, at step #11, the steam generating heaters 4 are driven. The temperature in the housing 2 thus is increased. At step #12, it is determined whether or not the on-time of the steam generating heaters 4 has elapsed. In a case where the on-time of the steam generating heaters 4 has not elapsed yet, steps #12 to #18 are performed in repeated cycles, i.e. the steam generation period ta continues. In a case where the on-time of the steam generating heaters 4 has elapsed, a transition is made to step #21 where switching to the heating period tb is performed.

At step #21, the steam generating heaters 4 and the water supply pump 21 are deactivated. At step #22, the convection heater 15 and the circulation fan 16 are driven. At step #23, it is determined whether or not the on-time of the convection heater 15 has elapsed. In a case where the on-time of the convection heater 15 has elapsed, at step #25, the convection heater 15 and the circulation fan 16 are deactivated, and a transition is made to step #11 where switching to the steam generation period ta is performed.

In a case where the on-time of the convection heater 15 has not elapsed yet, at step #24, it is determined whether or not a cooking period G1 (see FIG. 8) has been completed. In a case where the cooking period G1 has not been completed yet, steps #23 and #24 are performed in repeated cycles, i.e. the heating period tb continues.

In the case where, at step #12, it is determined that the on-time of the steam generating heaters 4 has not elapsed yet, a transition is made to step #13. At step #13, it is determined whether or not a time preceding the completion of the cooking period G1 by a predetermined length of time (for example, by one minute) has been reached. When the time preceding the completion of the cooking period G1 by the predetermined length of time is reached, a transition is made to step #17.

In a case where the time preceding the completion of the cooking period G1 by the predetermined length of time has not been reached yet, a transition is made to step #14 where it is determined whether or not the temperature in the housing 2 is higher than a predetermined driving temperature T1 (for example, 125° C.). In a case where the temperature in the housing 2 is not higher than the driving temperature T1, a transition is made to step #16. When the temperature in the housing 2 becomes higher than the driving temperature T1 (point E in FIG. 8), at step #15, driving of the water supply pump 21 is started.

Driving the water supply pump 21 causes water to be supplied into the housing 2 of the steam generating device 1 through the water supply port 3 as shown by an arrow B (see FIG. 3). The water supplied to the housing 2 accumulates in the bottom portion of the housing 2 and then is evaporated by the steam generating heaters 4 to form steam. At this time, the water, which has been brought to a bumping state in the bottom portion of the housing 2 by the steam generating heaters 4, is blocked by the blocking portion 7. The blocking portion 7 extends from the lid portion 2b at a temperature lower than the temperature at the main body portion 2a. Thus, droplets of water that has been carried up on the blocking portion 7 through bumping are not brought to a bumping state again but flow down from there on the blocking portion 7 along the bottom surface 7a as shown by an arrow D1 (see FIG. 3) to drip into the housing 2.

The steam generated in the lower portion of the housing 2 ascends in the housing 2 to exchange heat with the main body portion 2a and then is supplied to the heating chamber 11 through the ejection ports 8 as shown by an arrow C (see FIG. 3). At this time, condensation water produced at the ejection ports 8 by condensation resulting from cooling flows down the inclined lower inner wall surface of each of the ejection ports 8 as shown by an arrow D2 (see FIG. 3) and is allowed to drip on the blocking portion 7 and then into the housing 2.

During the heating period tb, the circulation fan 16 is driven to cause the steam supplied into the heating chamber 11 to flow into the circulation duct 12 via the air suction port 14. The steam flowing through the circulation duct 12 is heated by the convection heater 15 and then is blown out into the heating chamber 11 through the blow-out ports 13. Thus, steam in the heating chamber 11 is maintained at a predetermined temperature, and the object W to be cocked on the tray 17 is cooked using saturated steam or superheated steam.

At step #16, it is determined whether or not the temperature in the housing 2 is lower than a predetermined deactivation temperature T2. The deactivation temperature T2 is set to be a temperature (for example, 105° C.) lower than the driving temperature T1. In a case where the temperature in the housing 2 is not lower than the deactivation temperature T2, a transition is made to step #18. When the temperature in the housing 2 becomes lower than the deactivation temperature T2 (point F in FIG. 8), at step #17, driving of the water supply pump 21 is halted. This can suppress an increase in the amount of water stored in the housing 2.

Furthermore, when the deactivation temperature T2 is set to a temperature higher than 100° C., which is the boiling point of water, the housing 2 is maintained at a temperature higher than 100° C. This prevents the occurrence of condensation at the ejection ports 8, thereby allowing prevention of leakage of condensation water to the heating chamber 11.

At step #18, it is determined whether or not the cooking period G1 has been completed. In a case where the cooking period G1 has not been completed yet, steps #12 to #18 are preformed in repeated cycles.

Furthermore, when, at step #13, it is determined that the time preceding the completion of the cooking period G1 by the predetermined length of time has been reached, at step #17, the water supply pump 21 is deactivated regardless of the temperature in the housing 2. This brings about an evaporation period G2 (see FIG. 8) in which water in the housing 2 is evaporated and thus can prevent the water from remaining in the housing 2. In this case, a configuration is possible in which if, during the evaporation period G2, the temperature in the housing 2 becomes higher than a predetermined temperature (for example, 300° C.), the steam generating heaters 4 are deactivated. This can improve the safety of the cooker 10.

When it is determined, at step #18 or at step #24, that the cooking period G1 has been completed, the steam generating heaters 4, the convection heater 15, and the circulation fan 16 are deactivated, and the cooking thus is completed.

According to this embodiment, when the temperature in the housing 2 of the steam generating device 1 becomes higher than the driving temperature T1, driving of the water supply pump 21 (water supply unit) is started, and when the temperature in the housing 2 becomes lower than the deactivation temperature T2, the driving of the water supply pump 21 is halted. Thus, water does not accumulate in the housing 2 during a time from when the steam generating heaters 4 are started be driven to when a heated state thereof is attained, so that a phenomenon can be prevented in which the water is brought to a bumping state to spurt out through the ejection ports 8. Particularly in a case where water stored in the water supply tank 20 is hard water, bumping thereof is highly likely to occur. Even in such a case, however, it is possible to securely prevent the water from spurting out through the ejection ports 8.

Furthermore, if power supply to the steam generating heaters 4 is reduced and the temperature in the housing 2 thus becomes lower than the deactivation temperature T2, water supply is halted, and thus water can be prevented from overflowing through the ejection ports 8. This can prevent water leakage through the ejection ports 8, thereby allowing cooking to be performed with a good result.

Furthermore, since the deactivation temperature T2 is set to a temperature higher than 100° C., the occurrence of condensation at the ejection ports 8 is prevented, and thus it is possible to further prevent leakage of condensation water to the heating chamber 11.

Furthermore, since respective duty ratios of the steam generating heaters 4 and the convection heater 15 are controlled so that the steam generation period to and the heating period tb are brought about in repeated cycles, steam generation and steam heating can be preformed consecutively, thereby allowing cooking to be performed using steam maintained at a stable temperature.

Furthermore, since during the evaporation period G2 preceding the completion of cooking by the predetermined length of time, the water supply pump 21 is deactivated regardless of the temperature in the housing 2, water can be prevented from remaining in the housing 2.

Furthermore, since if, during the evaporation period G2, the temperature in the housing 2 exceeds a predetermined temperature, the steam generating heaters 4 are deactivated, and thus the safety of the cooker 10 can be improved.

Furthermore, since the blocking portion 7 is provided that extends from the lid portion 2b covering the open surface of the main body portion 2a in which the steam generating heaters 4 are embedded, and the blocking portion 7 is disposed between the ejection ports 8 and the steam generating heaters 4 so as to extend to the vicinity of the inner wall of the main body portion 2a, water being in a bumping state in the bottom portion of the housing 2 can be blocked by the blocking portion 7. Furthermore, since the blocking portion 7 is provided on the lid portion 2b at a temperature lower than the temperature at the main body portion 2a, droplets of water that has been carried up on the blocking portion 7 through bumping of the water caused in the bottom portion of the housing 2 are not brought to a bumping state again on the blocking portion 7 but drip into the housing 2. This can prevent water leakage through the ejection ports 8, thereby allowing cooking to be performed with a good result.

Particularly in a case where hard water is supplied through the water supply port 3, bumping thereof is highly likely to occur. Even in such a case, however, the blocking portion 7 provided on the lid portion 2b can securely prevent water from spurting out through the ejection ports 8.

Furthermore, since the lid portion 2b is joined to the main body portion 2a via the gasket 9, sealing between the lid portion 2b and the main body portion 2b is provided, and heat transfer from the main body portion 2a to the lid portion 2b is suppressed. This maintains the blocking portion 7 at a further decreased temperature, and thus it is possible to securely prevent water from spurting out through the ejection ports 8.

Furthermore, since the blocking portion 7 has the side surface portion 7b provided in a standing manner on each lateral side of the ejection ports 8 and thus has a U-shape in cross section, it is possible to more securely block water being in a bumping state in the bottom portion of the housing 2.

Furthermore, since the bottom surface 7a of the blocking portion 7 is an inclined surface, droplets of water that has been carried up on the blocking portion 7 can be allowed to drip swiftly into the housing 2. The bottom surface 7a may also be formed so as to be inclined downward toward the lid portion 2b or toward lateral sides (horizontal direction as facing the lid portion 2b).

Furthermore, since the ejection ports 8 protrude into the housing 2 and overlap the blocking portion 7 in a planar view, it is possible to more securely block water being in a bumping state in the bottom portion of the housing 2.

Furthermore, since the lower inner wall surface of each of the ejection ports 8 is inclined downward in a direction toward the lid portion 2b, condensation water produced at the ejection ports 8 is collected in the housing 2, and thus water leakage through the ejection ports 8 can be prevented.

In this embodiment, the water supply port 3 may be provided in the lid portion 2b. In such a configuration, the lid portion 2b is cooled by water passing through the water supply port 3, so that the blocking portion 7 is maintained at a further decreased temperature, and thus it is possible to securely prevent water from spurting out through the ejection ports 8.

Furthermore, the lid portion 2b may be made of a material, such as ceramic, having a thermal conductivity lower than that of metal. In such a configuration, heat transfer from the main body portion 2a having the steam generating heaters 4 to the lid portion 2b is suppressed, so that the blocking portion 7 is maintained at a further decreased temperature, and thus it is possible to securely prevent water from spurting out through the ejection ports 8. Furthermore, the ejection ports 8 may be provided in the lid portion 2b.

A configuration is also possible in which the lid portion 2b is divided into an upper portion having the blocking portion 7 and a lower portion opposed to the steam generating heaters 4, and the lower portion of the lid portion 2b is attached to the main body portion 2a via heat transfer grease or the like. This configuration improves thermal conduction between the lower portion of the lid portion 2b and the main body portion 2a and thus allows the lower portion of the lid portion 2b heated to a high temperature by heat transfer from the main body portion 2a to contribute to the evaporation of water. Thus, improved steam generation efficiency can be obtained.

### INDUSTRIAL APPLICABILITY

The present invention can be applied to a steam generating device that generates steam and a cooker using the same.

### LIST OF REFERENCE SIGNS

1 Steam generating device
2 Housing
2a Main body portion
2b Lid portion
3 Water supply port
4 Steam generating heater
5, 11c Temperature sensor
7 Blocking portion
8 Ejection port
9 Gasket
10 Cooker
11 Heating chamber
12 Circulation duct
13 Blow-out port
14 Air suction port
15 Convection heater
16 Circulation fan
20 Water supply tank
21 Water supply pump
22 Main body casing
23 Heat shield plate
30 Magnetron
31 Waveguide
32 Antenna
33 Electrical equipment portion
34 Cooling duct
35 Cooling fan
36 Air supply duct
37 Air supply fan
38 Air supply port
40 Air discharge duct
41 Air discharge port
42 Humidity sensor
50 Control portion
51 Operation portion
52 Display portion
53 Storage portion
54 Timer

1. A steam generating device, comprising:
a housing having a cavity inside;
a water supply port that is open into the housing;
a water supply unit that supplies water into the housing through the water supply port;
a steam generating heater that is embedded in the housing and evaporates water supplied through the water supply port;
an ejection port that is open into the housing and through which steam generated by the steam generating heater is ejected; and
a temperature sensor that detects a temperature in the housing,
wherein when the temperature in the housing becomes higher than a predetermined driving temperature, driving of the water supply unit is started, and when the temperature in the housing becomes lower than a predetermined deactivation temperature lower than the driving temperature, the driving of the water supply unit is halted.

2. The steam generating device according to claim 1, wherein
the deactivation temperature is set to a temperature higher than 100° C.

3. A steam generating device, comprising:
a housing that includes a box-shaped metallic main body portion having an open surface and a lid portion that covers the open surface, so that a cavity is formed inside the housing;
a water supply port through which water is supplied into the housing;
a steam generating heater that is embedded in the main body portion and evaporates water supplied through the water supply port;
an ejection port that is open into the main body portion at a level above a level of the steam generating heater and through which steam generated by the steam generating heater is ejected; and
a blocking portion that is disposed between the ejection port and the steam generating heater so as to extend from the lid portion to a vicinity of an inner wall of the main body portion.

4. The steam generating device according to claim 3, wherein
the lid portion is joined to the main body portion via a gasket.

5. The steam generating device according to claim 3, wherein
the blocking portion is constituted by an inclined surface.

6. The steam generating device according to claim 3, wherein
the blocking portion has a side surface portion provided in a standing manner on each lateral side of the ejection port and thus has a U-shape in cross section.

7. The steam generating device according to claim 3, wherein
the ejection port protrudes into the housing and overlaps the blocking portion in a planar view.

8. The steam generating device according to claim 7, wherein
a lower inner wall surface of the ejection port is inclined downward in a direction toward the lid portion.

9. The steam generating device according to claim 3, wherein
the water supply port is provided in the lid portion.

10. The steam generating device according to claim 3, wherein
the lid portion is made of ceramic.

11. A cooker, comprising:
the steam generating device according to claim 1;
a heating chamber that houses an object to be cooked and is supplied with steam through the ejection port;
a circulation fan that circulates steam in the heating chamber; and
a convection heater that heats steam being circulated by the circulation fan.

12. The cooker according to claim 11, wherein
respective duty ratios of the steam generating heater and the convection heater are controlled so that a steam generation period in which the steam generating heater is driven and a heating period in which the convection heater is driven are brought about in repeated cycles, and a period in which the water supply unit is driven is synchronized with timing for driving the steam generating heater.

13. The cooker according to claim 11, wherein
at a time preceding completion of cooking by a predetermined length of time, the water supply unit is deactivated regardless of the temperature in the housing.

14. The cooker according to claim 13, wherein
when the temperature in the housing exceeds a predetermined temperature during the predetermined length of time, the steam generating heater is deactivated.

15. A cooker, comprising:
the steam generating device according to claim 3;
a heating chamber that houses an object to be cooked and is supplied with steam through the ejection port;
a circulation fan that circulates steam in the heating chamber; and
a convection heater that heats steam being circulated by the circulation fan.

16. A cooker, comprising:
the steam generating device according to claim 2;
a heating chamber that houses an object to be cooked and is supplied with steam through the ejection port;
a circulation fan that circulates steam in the heating chamber; and
a convection heater that heats steam being circulated by the circulation fan.

17. A cooker, comprising:
the steam generating device according to claim 4;
a heating chamber that houses an object to be cooked and is supplied with steam through the ejection port;
a circulation fan that circulates steam in the heating chamber; and
a convection heater that heats steam being circulated by the circulation fan.

18. A cooker, comprising:
the steam generating device according to claim 5;
a heating chamber that houses an object to be cooked and is supplied with steam through the ejection port;
a circulation fan that circulates steam in the heating chamber; and
a convection heater that heats steam being circulated by the circulation fan.

19. A cooker, comprising:
the steam generating device according to claim 6;
a heating chamber that houses an object to be cooked and is supplied with steam through the ejection port;
a circulation fan that circulates steam in the heating chamber; and
a convection heater that heats steam being circulated by the circulation fan.

20. A cooker, comprising:
the steam generating device according to claim 7;
a heating chamber that houses an object to be cooked and is supplied with steam through the ejection port;
a circulation fan that circulates steam in the heating chamber; and
a convection heater that heats steam being circulated by the circulation fan.
